(19) United States
(12) Patent Application Publication
(10) Pub. No.: US 2004/0103775 A1
(43) Pub. Date: Jun. 3, 2004

(54) Pedal free cymbal device

(76) Inventor: Florentino Santos Vergara, West Covina, CA (US)

Correspondence Address: FLORENTINO S. VERGARA, 2651 HILLSBOROUGH PL., WEST COVINA, CA, 91792, US

(21) Appl. No.: 10/306,391

(22) Filed: Nov. 29, 2002

(51) Int. Cl. G10D 13/02

(52) U.S. Cl. 84/422.3

(57) ABSTRACT

A pedal free cymbal device that includes a shaft extending along an axis and two cymbals coaxially mounted on the shaft so that one of the cymbals is moveable in relation to the other. A triggering mechanism lever in this case is coupled to the shaft for displacing the moveable cymbal into engagement with one another. The lever is secured to the shaft and whose end is extended past the cymbals enabling the user to actuate the lever with any part of his or her hands or arms.

### BACKGROUND OF THE INVENTION

The invention relates to the field of percussion instruments. Typically, hi-hat cymbals consist of two cymbals that can be struck together for generating musical noises by hand or actuated by means of a foot operated pedal. The outer edges of the two cymbals are approximately equal diameter discs that create loud sounds when engaged with each other.

Classically, cymbals have been equipped with hand straps allowing the player to fully control the engagement of the cymbals with his arms. Through the obvious limitations, cymbals were mounted on stands to allow freedom for the percussionists to play many more variations and other percussion instruments as well.

Today, the most common configuration of playing cymbals is known as “hi-hat” and involves two cymbals opposably mounted on a floor stand and brought into engagement with one another by means of a foot pedal device. By actuating the foot pedal it enables the player to crash the two cymbals together giving the player the advantage of one or both hands free thus available to perform other functions like hitting the cymbals with sticks or brushes or to merely silence the sound.

To date, hi-hats are activated by a pedal using a foot. It is therefore the objective of the invention to provide a cymbal device that will free the feet of a percussionist and still allow him or her to actuate the hi-hats.

Another objective of the present invention is the possibility of locating the mechanism anywhere around the percussionist with the aid of a versatile clamping or mounting method.

### SUMMARY OF THE INVENTION

The device includes a shaft which extends along an axis. A pair of cymbals are coaxially mounted on the shaft so that one of the cymbals is moveable in relation to the other. By applying a light downward pressure on the end of the lever mechanism, the cymbals are brought into engagement with one another.

Another embodiment of the trigger mechanism is the use of cams at the end of the lever mechanism to actuate the engagement or disengagement of the other cymbals relative to the other in a smooth manner.

### BRIEF DESCRIPTION OF THE DRAWINGS

FIG. 1 and FIG. 3 is a plan view of the triggering device constructed in accordance with the invention, the cymbals shown in an engaged state.

FIG. 2 and FIG. 4 are clear views of the parts in the construction of the inventions.

### DETAILED DESCRIPTION

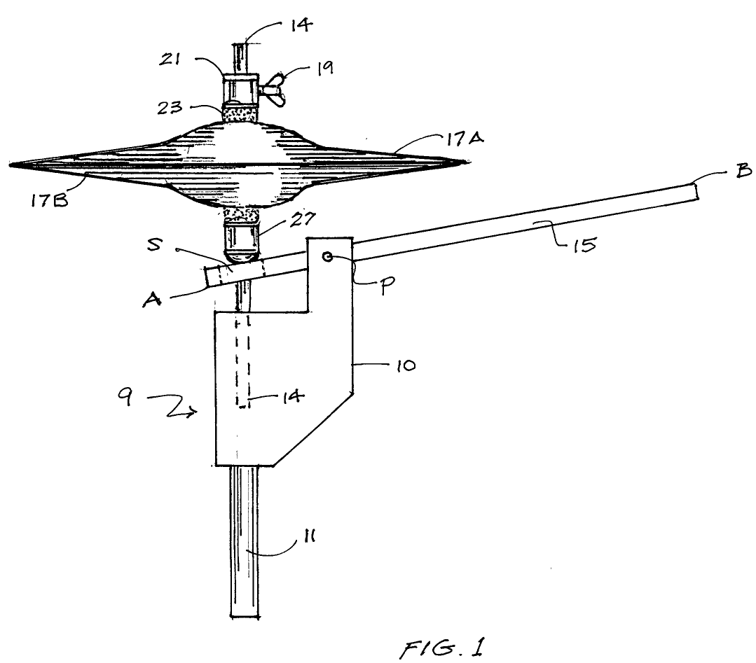

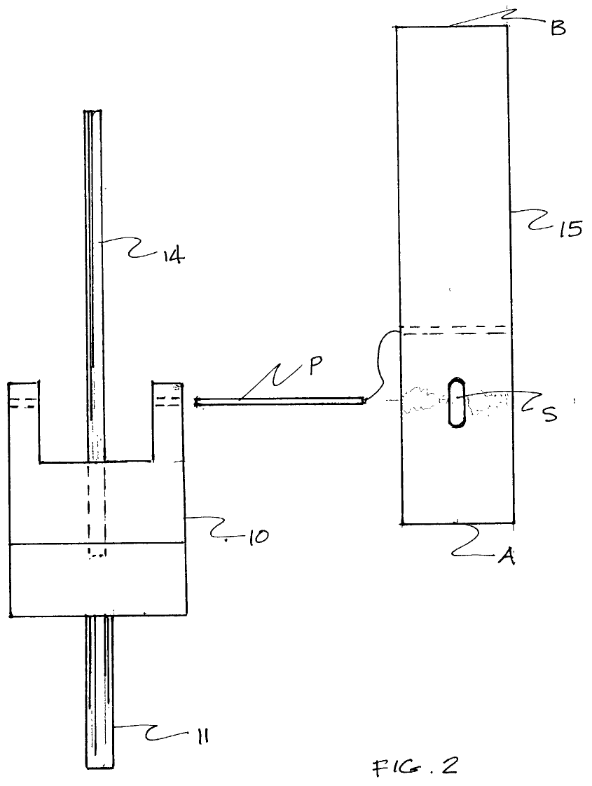

One embodiment of the invention is shown in FIG. 1 which depicts a device 9 including a mounting post 11. A main body 10, a shaft 14 and the lever mechanism 15. The trigger mechanism or lever is mounted on the body 10 at pt. P so that the user of the device can apply a downward pressure at pt B which pivotably brings an upward motion to the other end of the lever mechanism as it is slidably mounted on the shaft with slot S, raising the slidable cymbal 17B into engagement with the other cymbal 17A.

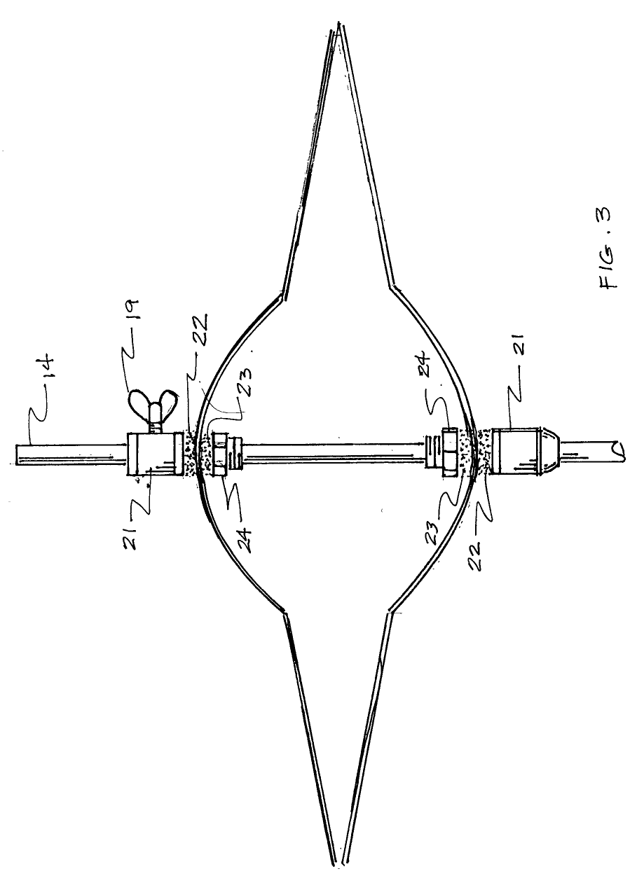

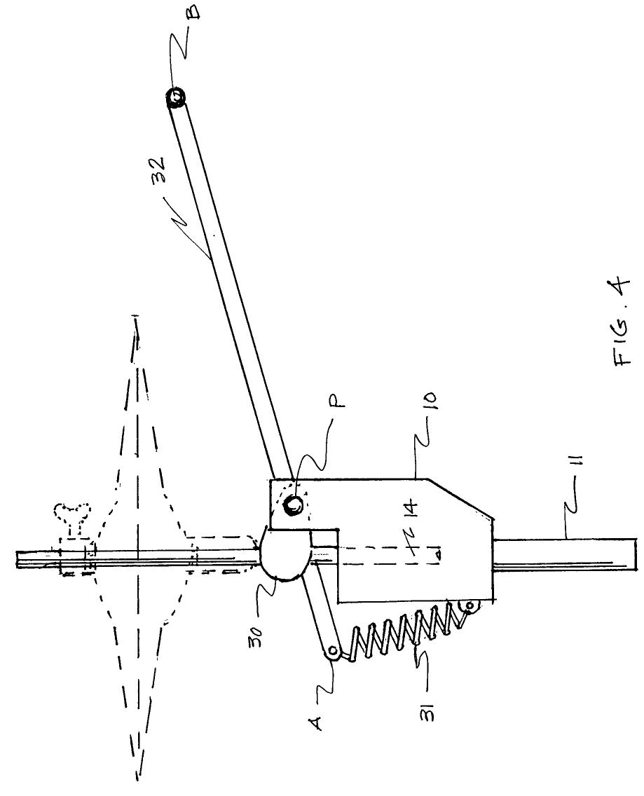

The cymbals 17A and 17B are coaxially mounted on shaft 14 whose ends extend beyond the cymbal 17A and the other mounted on the body 10. The cymbal 17A is secured to shaft 14 by a wing nut 19. As clearly illustrated in FIG. 3, the wing nut 19 screws into a threaded spacer 21 and nut 24 holding two felt spacers 22 and 23 slidably and can be secured to the shaft 14 with wing nut 19 to position the cymbal 17A at a certain distance from cymbal 17B. The bottom cymbal 17B is held into the shaft 14 by exactly the same spacer 21 and nut 24 above with two felts 22 and 23 but without the wing nut 19 and slides freely on shaft 14.

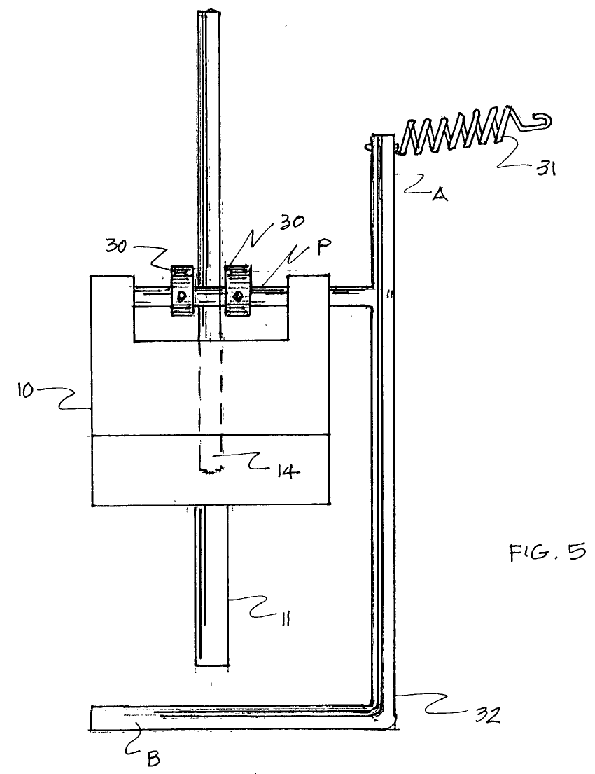

Another embodiment of the invention is shown in FIG. 4 which depicts a device 35 that includes a lever mechanism 32, main body 10, a shaft 14, a spring 31 and two cams 30 shown clearly in FIG. 5. The end of the lever 32 at point A is held by a spring 31 down so that the lower cymbal 17B is always in the disengaged position with top cymbal 17A. A downward pressure on the other end B will defeat the spring tension and make the cam rotate at pt. P and causes the slidably cymbal 17B to engage with the upper cymbal 17A. The cam 30 is utilized in this invention to provide a smooth engagement and disengagement of the two cymbals 17A and 17B.

While specific embodiments of the invention have been set forth in particular detail, it will be apparent to those ordinarily skilled in the art, that various alternatives to the described embodiments can be made without departing from the spirit and scope of the invention. The invention is to be defined, therefore, not by the preceding detailed description, but by the claims that follow.

What is claimed is:

1. A cymbal device for pedal free playing, comprising
a shaft extending along an axis
a first cymbal secured to the shaft
a second cymbal mounted slidably on the shaft and coaxially with the first cymbal
a trigger mechanism mounted to a body at a pivot point
the trigger mechanism including:
a first end extending away from the pivot point away from the second end,
the first end causes sliding movement of the second cymbal along the shaft in a direction substantially parallel to the axis and
a second end extending from the pivot point to an area near the edges of the two cymbals,
the second end for manipulation of the user with downward pressure using a part of the arm whereby the second cymbal slides along the shaft and contacts the first cymbal.

2. A cymbal device for pedal free playing comprising:
a shaft extending along an axis
a first cymbal secured to the shaft
a second cymbal mounted slidably on the shaft and coaxially with the first cymbal
a trigger mechanism mounted to a body at a pivot point, the trigger mechanism including:
a first end extending from a pivot point away from the second end
the first end accept a spring end whose other end is connected to the body
and causes constant downward pull
a pivot pin carrying two cams with the shaft between the two cams
a second end extending from the pivot point to an area near the edges of the two cymbals having an extended piece 90 degrees from the end of the second end the second end with the extended piece 90 degrees from the end for a manipulation by the user with downward pressure using hand or arm on any part of the second end will cause the pivot pin to rotate whereby the cams create an upward push to the second cymbal engaging the first cymbal.
